(19) United States
(12) Patent Application Publication
(10) Pub. No.: US 2025/0253444 A1
(43) Pub. Date: Aug. 7, 2025

(54) POWER STORAGE DEVICE AND VEHICLE

(71) Applicant: TOYOTA JIDOSHA KABUSHIKI KAISHA, Aichi-ken (JP)

(72) Inventors: Shigeyuki INOUE, Toyota-shi (JP); Kazuki SUGIE, Miyoshi-shi (JP); Yuki TAKAHASHI, Miyoshi-shi (JP)

(21) Appl. No.: 19/015,639

(22) Filed: Jan. 10, 2025

(30) Foreign Application Priority Data
Feb. 1, 2024 (JP) 2024-014358

(51) Int. Cl. H01M 10/658; H01M 50/249; H01M 50/271; H01M 50/289; H01M 50/30; H01M 50/583

(52) U.S. Cl. CPC H01M 10/658; H01M 50/249; H01M 50/271; H01M 50/289; H01M 50/394; H01M 50/583

(57) ABSTRACT

A power storage device includes: a power storage module including a power storage stack; a case including an upper cover; a pressure relief valve; a breathable membrane; and a shielding plate. The upper cover has a raised portion that is provided at a position overlapping the power storage stack in a Z direction and is raised upward. Each of the pressure relief valve and the breathable membrane is provided to the raised portion. The shielding plate is disposed between the raised portion and the power storage stack.

### CROSS REFERENCE TO RELATED APPLICATIONS

This nonprovisional application is based on Japanese Patent Application No. 2024-014358 filed on Feb. 1, 2024 with the Japan Patent Office, the entire contents of which are hereby incorporated by reference.

### BACKGROUND

### Field

The present disclosure relates to a power storage device and a vehicle.

### Description of the Background Art

Japanese Patent Laying-Open No. 2020-136072 discloses a battery pack including a plurality of battery stacks and a casing that accommodates the battery stacks.

### SUMMARY

Although not described in Japanese Patent Laying-Open No. 2020-136072, a pressure relief valve and a breathable membrane may be disposed on the casing. Here, a battery stack may emit sparks in such a case where the temperature rises excessively. In this case, it is conceivable that the sparks may be emitted from the pressure relief valve to the outside of the casing, or the breathable membrane may be affected by heat generated by the sparks or smoke from the battery stack.

The present disclosure has been made to solve the aforementioned problem, and an object thereof is to provide a power storage device and a vehicle that can suppress an adverse effect caused by sparks or smoke from a power storage stack when a pressure relief valve and a breathable membrane are provided to a case.

A power storage device according to a first aspect of the present disclosure includes: a power storage module including at least one power storage stack; a case that accommodates the power storage module; a pressure relief valve provided to the case; a breathable membrane; and a first shielding plate accommodated in the case. The case includes an upper cover provided to cover the power storage module from above. The upper cover has a raised portion that is provided at a position overlapping the at least one power storage stack in an up/down direction and is raised upward. Each of the pressure relief valve and the breathable membrane is provided to the raised portion. The first shielding plate is disposed between the raised portion and the at least one power storage stack.

In the power storage device according to the first aspect of the present disclosure, as described above, each of the pressure relief valve and the breathable membrane is provided to the raised portion, and the first shielding plate is disposed between the raised portion and the at least one power storage stack. Thereby, scattering of sparks from the power storage stack is prevented by the first shielding plate, and thus the sparks can be suppressed from being emitted from the pressure relief valve to the outside. Further, the first shielding plate can suppress the sparks or smoke from being (directly) scattered (blown) from the power storage cell to the breathable membrane. As a result, excessive heating of the breathable membrane due to the sparks or smoke can be suppressed. Thereby, it is possible to suppress an adverse effect caused by the sparks or smoke from the power storage stack.

Further, since each of the pressure relief valve and the breathable membrane is provided to the raised portion, the distance between the power storage stack and each of the pressure relief valve and the breathable membrane can be easily increased. As a result, the sparks from the power storage stack can be further suppressed from being scattered to each of the pressure relief valve and the breathable membrane. Further, the sparks or smoke can be further suppressed from being (directly) scattered from the power storage stack to the breathable membrane.

The power storage device according to the first aspect is preferably a power storage device disposed on a bottom portion of an electric device. Further, the power storage device further includes a seal member disposed to seal a gap between the raised portion and the bottom portion. The seal member is provided with a ventilation portion. With such a configuration, the seal member can cause a space between the raised portion and the bottom portion to be filled with the smoke. As a result, the ratio of oxygen in the space can be reduced. Further, since the seal member is provided with the ventilation portion, it is possible to suppress an excessive increase in the pressure in the space due to the smoke.

The power storage device according to the first aspect preferably further includes a second shielding plate different from the first shielding plate. The at least one power storage stack includes a plurality of power storage stacks. The plurality of power storage stacks include a lower-tier power storage stack disposed in a lower tier, and an upper-tier power storage stack disposed in an upper tier on the lower-tier power storage stack. The second shielding plate is provided between the upper-tier power storage stack and the raised portion. Here, since each of the pressure relief valve and the breathable membrane is provided to the raised portion raised upward, the pressure relief valve and the breathable membrane are provided relatively close to the upper-tier power storage stack. Thus, with such a configuration as described above, the sparks can be effectively suppressed from being scattered to each of the pressure relief valve and the breathable membrane. Further, the smoke can be effectively suppressed from being directly scattered from the power storage stack to the breathable membrane.

In this case, preferably, the upper cover has a lower-tier covering portion covering the lower-tier power storage stack, and an upper-tier covering portion covering the upper-tier power storage stack. The raised portion is provided on an upper surface of the lower-tier covering portion, at a position spaced apart from the upper-tier covering portion. The upper-tier covering portion includes a side surface covering the upper-tier power storage stack from a side. The side surface includes the second shielding plate. With such a configuration, a part of the upper-tier covering portion can be utilized as the second shielding plate, and thus an increase in the number of components can be suppressed, and the configuration of the power storage device can be simplified.

In the power storage device according to the first aspect, preferably, the pressure relief valve and the breathable membrane are disposed to be arranged in a predetermined direction intersecting the up/down direction. The first shielding plate is formed to extend in the predetermined direction so as to cover both the pressure relief valve and the breathable membrane from below. With such a configuration, the sparks from the power storage stack can be furthermore suppressed from being scattered to each of the pressure relief valve and the breathable membrane, by means of the first shielding plate. Further, the smoke can be furthermore suppressed from being directly scattered from the power storage stack to the breathable membrane.

In the power storage device according to the first aspect, preferably, the at least one power storage stack includes a first power storage stack and a second power storage stack arranged in a direction intersecting the up/down direction. The raised portion is provided to straddle the first power storage stack and the second power storage stack. With such a configuration, the distance from the first power storage stack to the pressure relief valve and the breathable membrane can be made equal to the distance from the second power storage stack to the pressure relief valve and the breathable membrane.

In the power storage device according to the first aspect, preferably, the power storage module includes a fuse. The at least one power storage stack is disposed in a first region. The fuse is disposed in a second region spaced apart from the first region, when the power storage module is viewed from a position spaced apart from the power storage module in the up/down direction. With such a configuration, the sparks or smoke generated from the power storage stack can be suppressed from coming into contact with the fuse. As a result, the fuse can be suppressed from being affected by heat.

A vehicle according to a second aspect of the present disclosure includes a vehicle body and the power storage device according to the first aspect. Thereby, it is possible to provide a vehicle that can suppress an adverse effect caused by sparks or smoke from a power storage stack.

In the vehicle according to the second aspect, preferably, the vehicle body includes an underbody. The power storage device is disposed on the underbody, and includes a seal member disposed to seal a gap between the raised portion and the underbody. The seal member is provided with a ventilation portion. With such a configuration, since the seal member is provided with the ventilation portion, it is possible to suppress an excessive increase in the pressure in a space between the underbody and the raised portion due to the smoke.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a view showing a configuration of a vehicle equipped with a power storage device according to one embodiment.

FIG. 2 is a perspective view showing a schematic configuration of the power storage device according to one embodiment.

FIG. 3 is a plan view showing the schematic configuration of the power storage device according to one embodiment.

FIG. 4 is a cross sectional view taken along a line IV-IV in FIG. 3.

FIG. 5 is a schematic plan view showing the power storage device according to one embodiment in a state in which an upper cover is removed therefrom.

FIG. 6 is a cross sectional view taken along a line VI-VI in FIG. 3.

FIG. 7 is a partially enlarged cross sectional view of the vicinity of a shielding plate according to a first modification of one embodiment.

FIG. 8 is a partially enlarged cross sectional view of the vicinity of a raised portion according to a second modification of one embodiment.

### DESCRIPTION OF THE PREFERRED EMBODIMENTS

An embodiment of the present disclosure will be described with reference to the drawings. It should be noted that, in the drawings referred to below, the same or corresponding members will be designated by the same reference numerals.

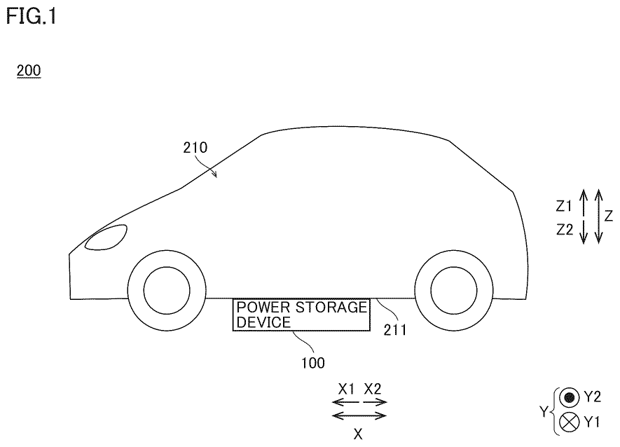

FIG. 1 is a view showing a vehicle 200 equipped with a power storage device 100 according to an embodiment of the present disclosure. Power storage device 100 is a device for storing electric power for driving vehicle 200. Vehicle 200 includes a plug-in hybrid electric vehicle (PHEV), a battery electric vehicle (BEV), or a fuel cell electric vehicle (FCEV), for example. It should be noted that vehicle 200 is an example of the “electric device” in the present disclosure.

An X direction, a Y direction, and a Z direction described in the present specification are directions orthogonal to each other. For example, the X direction and the Y direction may be a front/rear direction and a right/left direction, respectively, of vehicle 200. Further, the Z direction may be an up/down (vertical) direction. It should be noted that the Y direction is an example of the “predetermined direction” and the “direction intersecting the up/down direction” in the present disclosure. Further, the Z direction is an example of the “up/down direction” in the present disclosure.

Vehicle 200 includes a vehicle body 210, in addition to power storage device 100. Vehicle body 210 has an underbody 211. Underbody 211 is provided at a lower portion (bottom portion) of vehicle body 210. Power storage device 100 is disposed on underbody 211. Specifically, power storage device 100 is fixed (fastened) to underbody 211 below underbody 211. It should be noted that underbody 211 is an example of the “bottom portion” in the present disclosure.

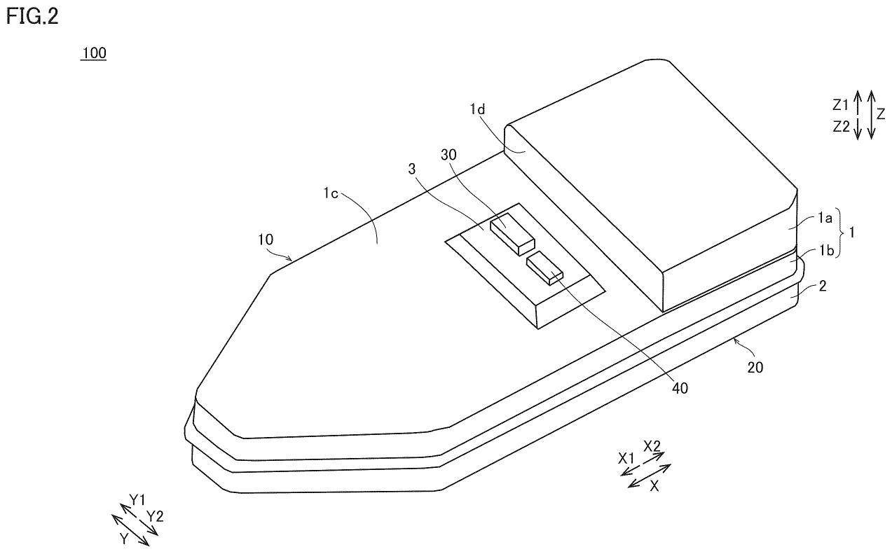

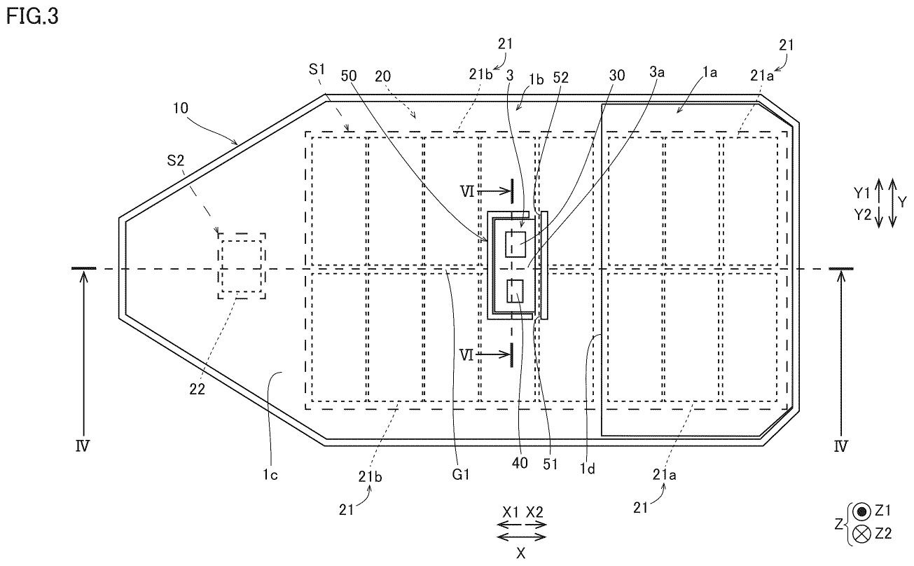

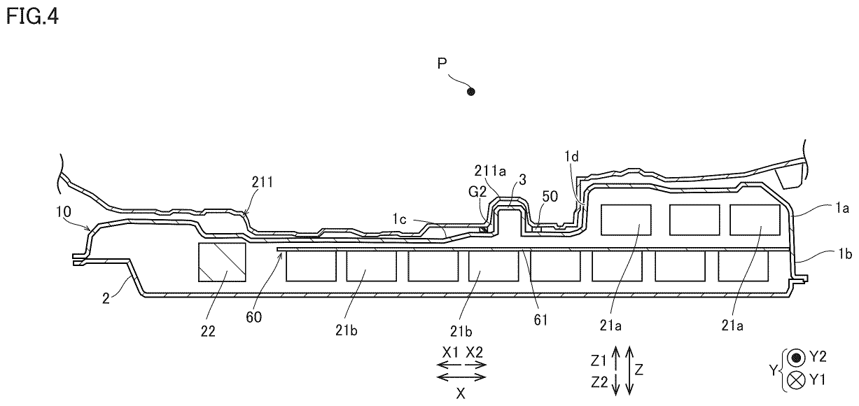

As shown in FIGS. 2 to 4, power storage device 100 includes a case 10, a power storage module 20 (see FIG. 3), a pressure relief valve 30, a breathable membrane 40, a seal member 50 (see FIG. 3), and a plate-like member 60 (see FIG. 4).

FIG. 2 is a perspective view schematically showing a configuration of power storage device 100. It should be noted that, in FIG. 2, seal member 50 described later is omitted for simplification.

As shown in FIG. 2, case 10 includes an upper cover 1 and a lower case 2. Upper cover 1 is disposed on a Z1 side of lower case 2 (above lower case 2). Upper cover 1 is provided to cover (close) lower case 2 from the Z1 side. Upper cover 1 is assembled with lower case 2 to form an accommodation space of case 10. Power storage module 20 (see FIG. 3) is disposed in the accommodation space. That is, upper cover 1 is provided to cover power storage module 20 from the Z1 side.

Upper cover 1 has an upper-tier covering portion 1a and a lower-tier covering portion 1b. Upper-tier covering portion 1a covers power storage stacks 21a described later. Lower-tier covering portion 1b covers power storage stacks 21b described later. Upper cover 1 and power storage stacks 21 described later each have a two-tier structure.

Upper-tier covering portion 1a is disposed on an X2 side with respect to the center of upper cover 1 in the X direction. Lower-tier covering portion 1b extends in the X direction to spread over the entire range in the X direction in which upper cover 1 is provided.

Lower-tier covering portion 1b has an upper surface 1c. Upper surface 1c is a surface extending to intersect (orthogonal to) the Z direction. Upper surface 1c is provided on an X1 side of upper-tier covering portion 1a.

Upper cover 1 has a raised portion 3. Raised portion 3 is raised toward the Z1 side. Specifically, raised portion 3 has a shape that is convex toward the Z1 side. It should be noted that FIG. 2 schematically shows raised portion 3.

Raised portion 3 is provided on upper surface 1c of lower-tier covering portion 1b. Raised portion 3 is raised from upper surface 1c of lower-tier covering portion 1b. Raised portion 3 is disposed at a position spaced apart from upper-tier covering portion 1a. It should be noted that a device or the like (not shown) may be disposed within case 10 at a position corresponding to raised portion 3.

Pressure relief valve 30 is provided to case 10. Pressure relief valve 30 releases the pressure inside case 10. Pressure relief valve 30 opens when the pressure inside case 10 becomes equal to or higher than a reference value. Pressure relief valve 30 is constituted by a check valve.

Breathable membrane 40 is provided to case 10. Breathable membrane 40 regulates the pressure inside case 10 by allowing passage of a gaseous body between the inside of case 10 and the outside of case 10.

Each of pressure relief valve 30 and breathable membrane 40 is provided to raised portion 3. Pressure relief valve 30 and breathable membrane 40 are disposed on raised portion 3 to be arranged in the Y direction. It should be noted that pressure relief valve 30 and breathable membrane 40 may be disposed on raised portion 3 to be arranged in the X direction.

As shown in FIG. 3, raised portion 3 is disposed to straddle two power storage stacks 21b (described later) arranged in the Y direction. Specifically, raised portion 3 is disposed such that a central portion 3a of raised portion 3 in the Y direction and a gap G1 between two power storage stacks 21b overlap each other in the Z direction.

As shown in FIG. 4, seal member 50 is disposed to seal a gap G2 between raised portion 3 and underbody 211. Seal member 50 is made of rubber or the like, for example. It should be noted that seal member 50 may be fixed by being inserted into a groove portion (not shown).

It should be noted that upper cover 1 has a shape conforming to the shape of underbody 211 of vehicle 200. Underbody 211 is provided with a recessed portion 211a corresponding to raised portion 3. Raised portion 3 enters recessed portion 211a of underbody 211. That is, raised portion 3 is accommodated in recessed portion 211a.

Referring to FIG. 3 again, seal member 50 is disposed to surround raised portion 3 when viewed from the Z1 side. That is, seal member 50 is formed in an annular shape when viewed from the Z1 side. It should be noted that seal member 50 may be disposed to overlap an outer peripheral edge, for example, of raised portion 3.

Seal member 50 is provided with a ventilation portion 51 and a ventilation portion 52. Smoke discharged from power storage module 20 described later is discharged from pressure relief valve 30 to the outside of case 10, and then passes through each of ventilation portion 51 and ventilation portion 52. It should be noted that each of ventilation portion 51 and ventilation portion 52 is an opening (slit) provided in a part of annular seal member 50.

Ventilation portion 51 is provided on a Y2 side with respect to raised portion 3 (pressure relief valve 30 and breathable membrane 40). Ventilation portion 52 is provided on a Y1 side with respect to raised portion 3 (pressure relief valve 30 and breathable membrane 40). Thereby, the smoke having passed through each of ventilation portion 51 and ventilation portion 52 can be suppressed from flowing to the front and the rear of vehicle 200.

Power storage module 20 includes a plurality of power storage stacks 21. The plurality of power storage stacks 21 include a plurality of power storage stacks 21a disposed in an upper tier and a plurality of power storage stacks 21b disposed in a lower tier. The upper tier (power storage stacks 21a) is (are) stacked on the lower tier (power storage stacks 21b). The upper tier (power storage stacks 21a) is (are) covered with upper tier covering portion 1a. The lower tier (power storage stacks 21b) is (are) covered with lower tier covering portion 1b. It should be noted that power storage stack 21a and power storage stack 21b are examples of the “upper-tier power storage stack” and the “lower-tier power storage stack”, respectively, in the present disclosure.

Raised portion 3 is disposed at a position overlapping a part of the plurality of power storage stacks 21 in the Z direction. Specifically, raised portion 3 is disposed at a position overlapping a part of the plurality of power storage stacks 21b in the Z direction.

Two power storage stacks 21 (two power storage stacks 21a, two power storage stacks 21b) are disposed to be arranged in the Y direction. In the upper tier, three sets of two power storage stacks 21a arranged in the Y direction are disposed to be arranged in the X direction. In the lower tier, eight sets of two power storage stacks 21b arranged in the Y direction are disposed to be arranged in the X direction. It should be noted that the number of sets is not limited to the above example. It should be noted that one and the other of two power storage stacks 21b arranged in the Y direction are examples of the “first power storage stack” and the “second power storage stack”, respectively, in the present disclosure.

Power storage module 20 includes a fuse 22. Fuse 22 is blown due to a large current flowing in power storage module 20. In this case, no current flows through power storage module 20.

The plurality of power storage stacks 21 are disposed in a region S1. Fuse 22 is disposed in a region S2 spaced apart from region S1, when power storage module 20 is viewed from a position P (see FIG. 4) spaced apart from power storage module 20 in the Z direction. Region S2 is disposed on the X1 side of region S1. Further, fuse 22 is disposed at a central portion of power storage device 100 in the Y direction. It should be noted that the position at which fuse 22 is disposed in the Y direction is not limited to the above example. Further, region S1 and region S2 are examples of the “first region” and the “second region”, respectively, in the present disclosure.

As shown in FIG. 4, plate-like member 60 is accommodated in case 10. Plate-like member 60 is located between a position where power storage stacks 21a are disposed and a position where power storage stacks 21b are disposed, in the Z direction. Plate-like member 60 extends in the X direction to span the plurality of power storage stacks 21b. A bus bar (not shown) used as an electrical wire within power storage module 20 is disposed (fixed) on plate-like member 60. It should be noted that plate-like member 60 is made of metal such as iron.

Here, a power storage stack may emit sparks or smoke in such a case where the temperature rises excessively. Specifically, the sparks or smoke are/is emitted from a safety valve of a power storage cell. In this case, it is conceivable that the sparks may be emitted from the pressure relief valve to the outside of the case, or the breathable membrane may be affected by heat generated by the sparks or smoke from the power storage stack.

Accordingly, in the present embodiment, a shielding plate 61 is disposed between raised portion 3 and the plurality of power storage stacks 21 (21b). Specifically, shielding plate 61 is disposed at a position underlying raised portion 3 in the Z direction. It should be noted that shielding plate 61 is an example of the “first shielding plate” in the present disclosure.

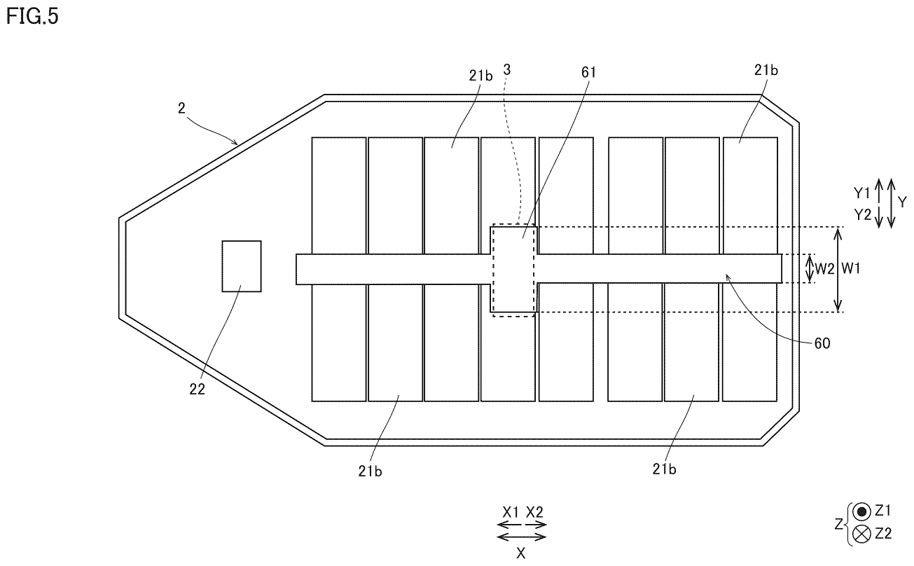

FIG. 5 is a plan view showing a schematic configuration of plate-like member 60. As shown in FIG. 5, shielding plate 61 is formed integrally with plate-like member 60. Plate-like member 60 (shielding plate 61) is provided to straddle two power storage stacks 21b arranged in the Y direction, at each position in the X direction.

Shielding plate 61 has a width W1 in the Y direction. The portion of plate-like member 60 other than shielding plate 61 has a width W2. Width W1 is larger than width W2. It should be noted that each of width W1 and width W2 may vary depending on the position in the X direction. In this case, the minimum value of width W1 is larger than the maximum value of width W2.

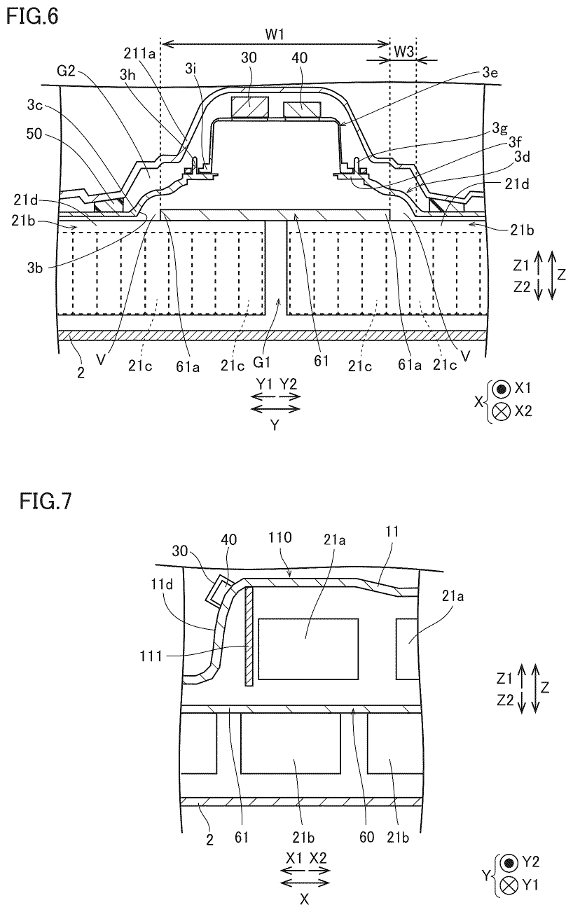

As shown in FIG. 6, shielding plate 61 is formed to extend in the Y direction so as to cover both pressure relief valve 30 and breathable membrane 40 from a Z2 side. In other words, shielding plate 61 is formed to be wide in the Y direction. Shielding plate 61 is provided to close an opening 3b of raised portion 3. Opening 3b is provided at a lower end portion 3c of raised portion 3. Lower end portion 3c is formed in an annular shape.

It should be noted that raised portion 3 is not provided with an opening other than opening 3b. Thereby, smoke generated in power storage stack 21 can be suppressed from reaching pressure relief valve 30 and breathable membrane 40 on raised portion 3. As a result, influence of heat on breathable membrane 40 can be reduced.

A void V that is not closed by shielding plate 61 is formed in opening 3b. Void V is formed between an outer peripheral edge 61a of shielding plate 61 and lower end portion 3c of raised portion 3. The smoke generated in power storage stack 21 passes through void V and flows toward pressure relief valve 30. It should be noted that a width W3 of void V is smaller than width W1 of shielding plate 61 in the Y direction. Width W3 is less than or equal to ½ of width W1. For example, width W3 may be more than or equal to 1/10 of width W1 and less than or equal to ⅛ of width W1. It should be noted that the relation between width W1 and width W3 is not limited to the above example.

Each power storage stack 21 includes a plurality of power storage cells 21c and a cell case 21d. The plurality of power storage cells 21c are accommodated in cell case 21d. Shielding plate 61 (plate-like member 60) is supported by cell case 21d from the Z2 side. In other words, shielding plate 61 (plate-like member 60) is placed on cell case 21d. Smoke from each power storage cell 21c is discharged from an exhaust valve (not shown) provided at an upper portion (upper end surface) of cell case 21d, for example. It should be noted that the number of power storage cells 21c accommodated in cell case 21d may be one. Further, in the present embodiment, in cell case 21d, the plurality of power storage cells 21c having a longitudinal direction in the X direction are arranged in the Y direction. It should be noted that, in cell case 21d, a plurality of power storage cells having a longitudinal direction in the Y direction may be arranged in the X direction.

Raised portion 3 includes a base portion 3d and a cap portion 3e. Base portion 3d is formed to be contiguous to a portion of upper cover 1 adjacent to raised portion 3 (a portion around raised portion 3). Base portion 3d is formed to be raised toward the Z1 side. It should be noted that the configuration of raised portion 3 is not limited to the above example. For example, the raised portion may not be provided with cap portion 3e.

Cap portion 3e is placed on base portion 3d. Cap portion 3e is fixed to an upper end portion 3f of base portion 3d. Upper end portion 3f of base portion 3d is provided with a protruding portion 3g protruding toward the Z1 side. Cap portion 3e includes a flange portion 3i provided with a hole portion 3h. By inserting protruding portion 3g into hole portion 3h, cap portion 3e is fixed to (engaged with) base portion 3d. It should be noted that each of protruding portion 3g and hole portion 3h may be formed in an annular shape, for example. Further, a plurality of protruding portions 3g (a plurality of hole portions 3h) may be circumferentially arranged.

Cap portion 3e is formed to be convex toward the Z1 side. It should be noted that each of pressure relief valve 30 and breathable membrane 40 is provided to cap portion 3e. Specifically, each of pressure relief valve 30 and breathable membrane 40 is provided at an upper end portion of cap portion 3e.

Referring to FIG. 4 again, upper-tier covering portion 1a includes a side surface 1d covering power storage stacks 21a from the side. Specifically, side surface 1d covers power storage stacks 21a from the X1 side (the raised portion 3 side). It should be noted that side surface 1d is an example of the “second shielding plate” in the present disclosure.

Side surface 1d is provided between raised portion 3 and power storage stacks 21a. Specifically, side surface 1d is provided between raised portion 3 and power storage stack 21a closest to the X1 side (the raised portion 3 side) among the plurality of power storage stacks 21a. It should be noted that side surface 1d is provided along cell case 21d (see FIG. 6) of power storage stack 21a.

Side surface 1d extends from the vicinity of a position where lower end portion 3c (see FIG. 6) of raised portion 3 is provided, to a position above a position where an upper end portion of power storage stack 21a is provided, in the Z direction.

As described above, in power storage device 100 according to the present embodiment, shielding plate 61 is disposed between raised portion 3 and power storage stacks 21b. Thereby, a space between raised portion 3 and power storage stacks 21b can be divided by shielding plate 61. As a result, sparks generated in power storage stack 21b can be suppressed from being scattered upward from shielding plate 61. Thereby, the sparks can be suppressed from being scattered to pressure relief valve 30 and breathable membrane 40. Further, shielding plate 61 can prevent the flow of smoke from power storage stack 21b.

Further, in the present embodiment, seal member 50 that seals gap G2 between raised portion 3 and underbody 211 is provided with a ventilation portion (51, 52). Thereby, since seal member 50 causes gap G2 to be filled with the smoke from power storage stack 21, the ratio of oxygen in gap G2 can be reduced. Further, since the smoke is discharged from the ventilation portion (51, 52), the pressure in gap G2 can be maintained at a constant value or less.

Further, in the present embodiment, upper-tier covering portion 1a includes side surface 1d covering power storage stacks 21a from the side. Thereby, side surface 1d can prevent scattering of sparks or smoke from power storage stack 21a. As a result, the sparks generated in power storage stack 21a can be suppressed from reaching raised portion 3. Further, the smoke can be suppressed from being directly scattered from power storage stack 21a to raised portion 3.

Although the above embodiment has described an example in which side surface 1d of upper cover 1 is provided between raised portion 3 and power storage stacks 21a, the present disclosure is not limited thereto. As shown in FIG. 7, each of pressure relief valve 30 and breathable membrane 40 may be provided to a side surface 11d of an upper cover 11 of a case 110. Side surface 11d is formed to be raised toward the Z1 side. It should be noted that side surface 11d is an example of the “raised portion” in the present disclosure.

Upper cover 11 is provided with a shielding plate 111. Shielding plate 111 is provided inside case 110. Shielding plate 111 is provided between side surface 11d and power storage stack 21a closest to the X1 side (the side surface 11d side) among the plurality of power storage stacks 21a. Side surface 11d is provided along power storage stack 21a closest to the X1 side. Shielding plate 111 is provided to extend in the Z direction. It should be noted that shielding plate 111 may be formed integrally with upper cover 11. Further, shielding plate 111 may be separate from upper cover 11 and fixed to upper cover 11. It should be noted that shielding plate 111 is an example of the “second shielding plate” in the present disclosure.

Although the above embodiment has described an example in which the plurality of power storage stacks 21 are provided in power storage module 20, the present disclosure is not limited thereto. The number of power storage stacks provided in the power storage module may be one.

Although the above embodiment has described an example in which seal member 50 that seals gap G2 between underbody 211 and raised portion 3 is provided, the present disclosure is not limited thereto. Seal member 50 may not be provided.

Although the above embodiment has described an example in which seal member 50 is provided with the ventilation portion (51, 52), the present disclosure is not limited thereto. The seal member may not be provided with a ventilation portion. Further, a ventilation portion may be formed by providing a through hole in the seal member.

Although the above embodiment has described an example in which the ventilation portion (51, 52) of seal member 50 is provided on each of the Y1 side and the Y2 side of pressure relief valve 30 and breathable membrane 40, the present disclosure is not limited thereto. The ventilation portion may be provided on only one of the Y1 side and the Y2 side of pressure relief valve 30 and breathable membrane 40. Further, the ventilation portion may be provided on at least one of the X1 side and the X2 side of pressure relief valve 30 and breathable membrane 40.

Although the above embodiment has described an example in which pressure relief valve 30 and breathable membrane 40 are provided to the same raised portion 3, the present disclosure is not limited thereto. Pressure relief valve 30 and breathable membrane 40 may be provided to raised portions different from each other.

Although the above embodiment has described an example in which power storage device 100 is disposed on underbody 211 of vehicle 200, the present disclosure is not limited thereto. Power storage device 100 may be disposed on a bottom portion of an electric device other than a vehicle (for example, a stationary power storage device).

Although the above embodiment has described an example in which power storage module 20 includes power storage stacks 21a in the upper tier and power storage stacks 21b in the lower tier, the present disclosure is not limited thereto. The power storage module may not include power storage stacks in the upper tier.

Although the above embodiment has described an example in which width W1 of shielding plate 61 is larger than width W2 of the portion of plate-like member 60 other than shielding plate 61, the present disclosure is not limited thereto. For example, width W2 may be equal to width W1.

Although the above embodiment has described an example in which shielding plate 61 is a part of plate-like member 60, the present disclosure is not limited thereto. Shielding plate 61 may be separate from plate-like member 60.

Although the above embodiment has described an example in which raised portion 3 is disposed to straddle two power storage stacks 21b arranged in the Y direction, the present disclosure is not limited thereto. Raised portion 3 may be disposed to overlap only one of two power storage stacks 21b in the Z direction.

Although the above embodiment has described an example in which region S1 in which power storage stacks 21 are provided is spaced apart from region S2 in which fuse 22 is provided, the present disclosure is not limited thereto. For example, region S1 and region S2 may overlap each other in the Z direction. Further, region S1 and region S2 may be adjacent to each other in plan view.

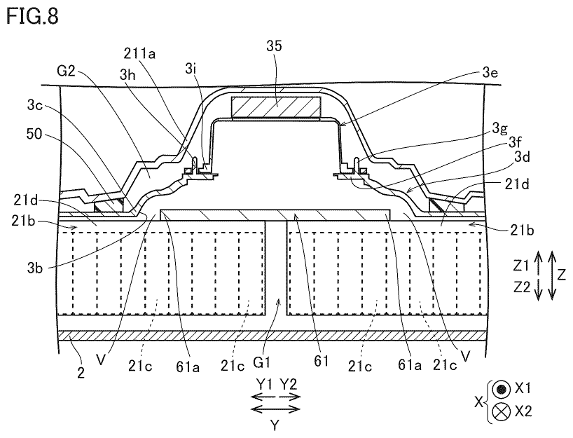

Although the above embodiment has described an example in which pressure relief valve 30 and breathable membrane 40 are separately provided, the present disclosure is not limited thereto. The pressure relief valve may be provided integrally with the breathable membrane. In the example shown in FIG. 8, a single member 35 integrally having the functions of pressure relief valve 30 and breathable membrane 40 is provided to cap portion 3e. It should be noted that member 35 is an example of the “pressure relief valve” and the “breathable membrane” in the present disclosure.

Although the above embodiment has described an example in which two power storage stacks 21 are disposed to be arranged in the Y direction, the present disclosure is not limited thereto. Power storage stacks 21 may not be disposed to be arranged in the Y direction. Further, three or more power storage stacks 21 may be disposed to be arranged in the Y direction.

Although the above embodiment has described an example in which raised portion 3 is provided to lower-tier covering portion 1b, the present disclosure is not limited thereto. Raised portion 3 may be provided to upper-tier covering portion 1a.

It should be noted that the configurations of the embodiment and the various modifications described above may be combined with each other.

Although the embodiment of the present disclosure has been described, it should be understood that the embodiment disclosed herein is illustrative and non-restrictive in every respect. The scope of the present disclosure is defined by the scope of the claims, and is intended to include any modifications within the scope and meaning equivalent to the scope of the claims.

What is claimed is:

1. A power storage device comprising:
a power storage module including at least one power storage stack;
a case that accommodates the power storage module;
a pressure relief valve provided to the case;
a breathable membrane; and
a first shielding plate accommodated in the case, wherein
the case includes an upper cover provided to cover the power storage module from above,
the upper cover has a raised portion that is provided at a position overlapping the at least one power storage stack in an up/down direction and is raised upward,
each of the pressure relief valve and the breathable membrane is provided to the raised portion, and
the first shielding plate is disposed between the raised portion and the at least one power storage stack.

2. The power storage device according to claim 1, wherein
the power storage device is disposed on a bottom portion of an electric device,
the power storage device further comprises a seal member disposed to seal a gap between the raised portion and the bottom portion, and
the seal member is provided with a ventilation portion.

3. The power storage device according to claim 1, further comprising a second shielding plate different from the first shielding plate, wherein
the at least one power storage stack includes a plurality of power storage stacks,
the plurality of power storage stacks include
a lower-tier power storage stack disposed in a lower tier, and
an upper-tier power storage stack disposed in an upper tier on the lower-tier power storage stack, and
the second shielding plate is provided between the upper-tier power storage stack and the raised portion.

4. The power storage device according to claim 3, wherein
the upper cover has
a lower-tier covering portion covering the lower-tier power storage stack, and
an upper-tier covering portion covering the upper-tier power storage stack,
the raised portion is provided on an upper surface of the lower-tier covering portion, at a position spaced apart from the upper-tier covering portion,
the upper-tier covering portion includes a side surface covering the upper-tier power storage stack from a side, and
the side surface includes the second shielding plate.

5. The power storage device according to claim 1, wherein
the pressure relief valve and the breathable membrane are disposed to be arranged in a predetermined direction intersecting the up/down direction, and
the first shielding plate is formed to extend in the predetermined direction so as to cover both the pressure relief valve and the breathable membrane from below.

6. The power storage device according to claim 1, wherein
the at least one power storage stack includes a first power storage stack and a second power storage stack arranged in a direction intersecting the up/down direction, and
the raised portion is provided to straddle the first power storage stack and the second power storage stack.

7. The power storage device according to claim 1, wherein
the power storage module includes a fuse,
the at least one power storage stack is disposed in a first region, and
the fuse is disposed in a second region spaced apart from the first region, when the power storage module is viewed from a position spaced apart from the power storage module in the up/down direction.

8. A vehicle comprising:
a vehicle body; and
the power storage device according to claim 1.

9. The vehicle according to claim 8, wherein
the vehicle body includes an underbody,
the power storage device
is disposed on the underbody, and
includes a seal member disposed to seal a gap between the raised portion and the underbody, and
the seal member is provided with a ventilation portion.
